(19) United States
(12) Patent Application Publication
(10) Pub. No.: US 2008/0272625 A1
(43) Pub. Date: Nov. 6, 2008

(54) Arrangement for Sealing an Opening of a Vehicle With a Window and an Anti-Splinter Element

(75) Inventors: Werner Paetz, Hofstetten (DE); Eric Binder, Stockdorf (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Webasto AG, Stockdorf (DE)

(21) Appl. No.: 11/571,087

(22) PCT Filed: Feb. 14, 2005
(86) PCT No.: PCT/EP2005/001459

§ 371 Date: Dec. 21, 2006

(30) Foreign Application Priority Data
Feb. 18, 2004 (DE) 102004007988.9

(51) Int. Cl. B60J 10/12

(52) U.S. Cl. 296/216.09

(57) ABSTRACT

An arrangement for closing an opening of a motor vehicle, which has a pane (14), a shatter-proofing element (30) attached to the pane or a function element located on the pane, the shatter-proofing element being connected to the vehicle body or a retaining element (18) which is connected to the vehicle body by means of a first permanent elastic cement bond (20). Furthermore, a peripheral foam (12) is provided in the edge area of the pane and is connected to the vehicle body or the retaining element by a second permanent elastic cement bond (22).

### BACKGROUND OF THE INVENTION

1. Field of the Invention

This invention relates to an arrangement for closing an opening of a motor vehicle, especially a roof opening, with a pane which is provided with a shatter-proofing element.

2. Description of Related Art

German Patent Application DE 43 23 140 A1 discloses a glass cover for a vehicle roof, the glass pane on its underside being provided with a transparent film, the edge area of which is embedded into foam that is provided around the edge of the pane. Furthermore, the inner cover sheet is foamed into the peripheral foam.

A similar glass cover is described in German Patent Application DE 102 06 717 A1 and corresponding U.S. Pat. No. 6,908,147, between the elastic film and the underside of the glass pane, a solar generator being enclosed. Similar solar covers are described in German Patent Application DE 41 05 396 A1 and German Patent Application DE 101 55 168 A1 that corresponds to U.S. Pat. No. 6,867,893. However instead of a solar generator, an electrochrome element is enclosed between the film and the pane.

German Patent Application DE 101 51 156 A1 and corresponding U.S. Pat. No. 6,942,288 describe a glass cover in which a shatter-proofing film is cemented directly to the underside of the glass pane, the edge area of the shatter-proofing film extending into the peripheral foam and being provided with holes in order to achieve a better connection to the peripheral foam.

In commonly-owned International Patent Application WO 2004/073976 A1, which published after the international filing date of this application, various embodiments of glass covers with a shatter-proofing film are described, the edge area of the shatter-proofing film being foamed into the peripheral cover foam of the pane or being cemented into a cement connection between the pane edge and the inner cover sheet. In the edge area of the film there are means to increase adhesion to the peripheral foam or a cement bond.

German Patent Application DE 101 55 170 A1 discloses a glass fixing element for a vehicle roof which is cemented to the body-mounted roof frame by means of a cement bond. There is no shatter-proofing film there.

Furthermore, cementing vehicle roof modules into the body frame of the vehicle from overhead by means of a cement bead is known, see, for example, German Patent Application DE 198 17 056 A1, German Patent DE 199 55 710 C1 and German Patent Application DE 102 23 579 A1.

### SUMMARY OF THE INVENTION

The object of this invention is to devise an arrangement for closing an opening of a motor vehicle, especially a roof opening, with a pane, with provision being made for protection of passengers and the vehicle interior as much as possible when the pane breaks, and furthermore, for attachment of the pane to the vehicle body or a retaining element connected to the vehicle body in a simple and economical manner.

This object is achieved in accordance with the invention by an arrangement as described herein.

Each of the approaches in accordance with the invention enable a simple and still economical connection of the pane, which is provided with the shatter-proofing element, to the vehicle body. The shatter-proofing element performs the task of retaining the fragments of the broken pane when it breaks by the shatter-proofing element being connected securely to the retaining element and the vehicle body in its edge area, the shatter-proofing element, with the pane broken, is no longer being flexural stiff, but is held in place by the retaining element or the vehicle body. In this way, the passengers can be prevented from being flung to the outside through the broken pane, articles and fragments from outside can be prevented from penetrating into the interior through the broken pane, and the interior is prevented from being freely accessible when the pane is destroyed in case of break-in.

The invention is especially suited for pane arrangements which are a so-called glass fixing element, i.e., a glass pane which is attached fixed in the opening of the vehicle, especially in a roof opening.

The invention is explained in detail by way of examples below with reference to the accompanying drawings.

### BRIEF DESCRIPTION OF THE DRAWINGS

FIG. 1 is a lengthwise sectional view of the front edge area of an arrangement in accordance with the invention according to a first embodiment;

FIGS. 2 and 3 show views, like FIG. 1, a second and a third embodiment;

FIG. 4 shows a view, like FIG. 3, however, with the rear edge area of the pane arrangement being shown; and

FIG. 5 shows a view, like FIG. 1, of a fourth embodiment.

### DETAILED DESCRIPTION OF THE INVENTION

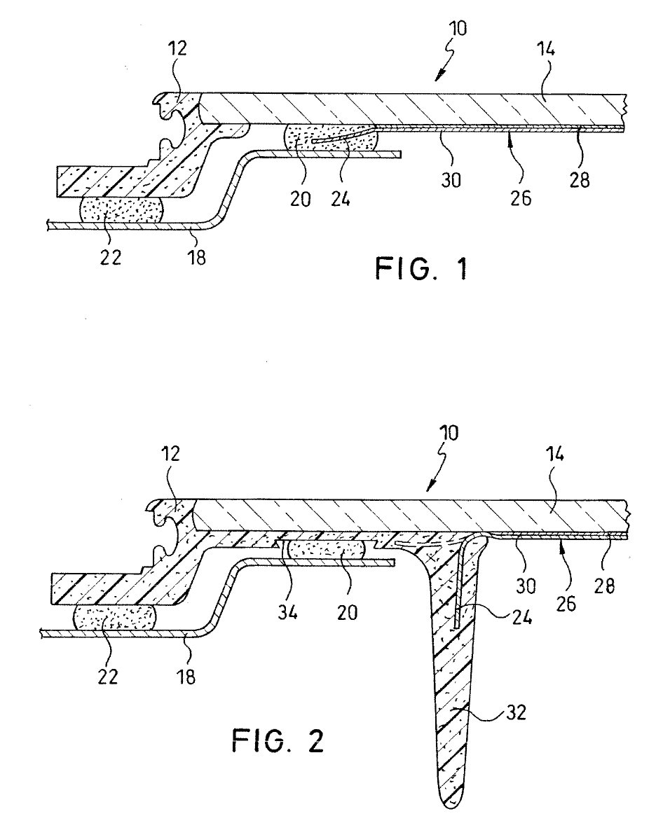

FIG. 1 shows a first embodiment of a pane arrangement 10 which is, for example, a windshield, side window or roof pane for a motor vehicle, but can also be a pane for ships, boats, tractors, construction vehicles and the like. The pane arrangement 10 comprises a preferably at least partially transparent glass pane 14 which is preferably made from heat-tempered single-pane safety glass. In its edge area, the pane 14 is provided with peripheral foam 12, preferably of polyurethane, which extends in part beyond the edge of the pane 14. In the edge area of the pane 14 or in the region of the peripheral foam 12, there is a retaining element 18 which, for its part, is connected to the vehicle body. The retaining element 18 is preferably rigidly connected to the vehicle body in order, in this way, to effect a secure connection between the glass pane 14 and the vehicle body, in this case, the opening of the vehicle closed by the glass pane 14 being permanently closed by it. However, basically embodiments are possible in which the retaining element 18 is movably connected to the vehicle body so that, in this case, the pane arrangement 10 can be moved in order to selectively at least partially clear the opening of the vehicle body that is closed by the pane arrangement 10.

As shown in FIG. 1, the retaining element 18, on the one hand, is cemented directly to the underside of the pane 14 by means of first cement bond or cement connection 20, and on the other hand, the underside of the peripheral foam 12 is also securely joined to the retaining element 18 in the part projecting beyond the pane edge by means of second cement bond 22. The first cement bond 20 and second cement bond 22 are each formed by a cement bead, and are permanently elastic, in contrast to the peripheral foam 12.

In its central area, the pane 14 is laminated or cemented on its side facing the vehicle interior with a protective film composite 26 which, on its side facing the pane 14, is provided with an adhesive film or adhesive layer 28, which is used to cement the shatter-proofing film 30, which is made tear-proof and scratchproof to the pane 14. The adhesive film 28 can be, for example, a poly(vinylbutyral) film (PVB film) or a transparent polyurethane (PU) film, while the protective film 30 is preferably a plastic film which is coated to be scratchproof, for example, a polysiloxane-coated poly(ethyleneterephthalate) film (PET film) or a polycarbonate film (PC film).

In its peripheral edge area 24, the protective film composite 26 extends into the first cement bond 20, being embedded at least partially in the first cement bond 20 or extending into it, i.e., in this area, the protective film composite 26 does not adjoin the pane 14. The peripheral edge area 24 and part of the central area of the protective film composite 26 lay between the retaining element 18 and the pane 14. The adhesive film or adhesive layer 28 can be absent in the edge area 24 of the protective film composite 26 that does not adjoin the pane 14.

The first cement bond 20 thus is used not only to connect the retaining element 18 to the pane 14 in interaction with the second cement bond 22, but is also used to securely join the protective film composite 26 to the retaining element 18. In this way, it can be ensured that, even when the glass pane 14 breaks, a certain mechanical integrity of the pane arrangement 10 is preserved by the protective film composite 26, even with the pane 14 broken, remaining clamped in its edge area by means of the retaining element 18 which, for its part, is connected to the vehicle body. In this connection, the protective film composite 26 does lose its flexural stiffness, but remains in place with respect to the retaining element 18, by which, on the one hand, the passengers can be prevented from being flung to the outside through the broken pane 14, and on the other hand, fragments of the pane and articles from outside can be prevented from penetrating into the vehicle interior. Furthermore, in the case of intentional destruction of the glass pane 14, the protective film composite 26 can also provide for a certain protection against break-in. The fragments of the broken glass pane 14 remain hanging on the protective film composite 26, i.e., on the protective film 30, due to the adhesive layer 28. In this way, the protective film 30 acts as a shatter-proofing film.

FIG. 2 shows a modified embodiment in which the peripheral foam 12 extends farther along the bottom of the pane 14 to the central area of the pane 14, the innermost section of the peripheral foam 12 forming a screen 32 which projects down from the underside of the pane 14 in order to cover the edge area of the pane arrangement 10, especially the retaining element 18, with respect to the vehicle interior. The edge area 24 of the protective film composite 26 extends into the screen 32, the edge area 24 being able to run, for example, essentially parallel to the pane 14 (see broken lines in FIG. 2) or essentially perpendicular to the glass pane 14 (see solid lines in FIG. 2).

In the area of the first cement bond 20, the underside of the peripheral foam 12 is provided with a depression 34 which has been mechanically worked out by surface machining, and which can be made, for example, by milling. Surface machining in the area of the depression 34 removes residues of the separating agent from the foaming process so that cement can be applied there. The upper part of the first cement bond 20 in the illustrated example essentially fills the depression 34. In contrast to the embodiment from FIG. 1, thus, in the embodiment as shown in FIG. 2, the first cement bond 20 does not directly adjoin the underside of the pane 14, but the underside of the peripheral foam 12.

The screen 32 is located nearer to the central area of the pane 14 than the first cement bond 20, i.e., is on the inner side of the cement bond 20.

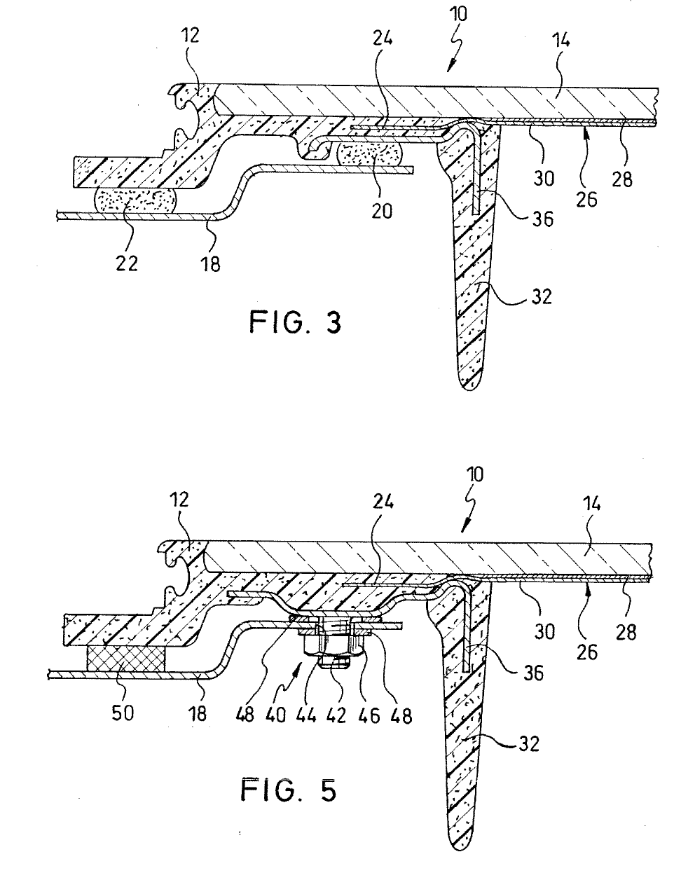

FIG. 3 shows an embodiment which is essentially modified with respect to the embodiment from FIG. 2 in that a fastening element 36, which is made as a sheet metal profile, is also foamed into the peripheral foam 12 extending across the area of the first cement bond 20 in order to be used as the cement surface for the first cement bond 20 instead of the bottom of the peripheral foam 12. For this purpose, the underside of the fastening element 36 is exposed in the region of the first cement bond 20 at the underside of the peripheral foam 12.

As is shown in FIG. 3, one leg of the fastening element 36 can extend into the part of the screen 32 which projects down.

Furthermore, in the FIG. 3 embodiment, the edge area 24 of the film composite 26 extends beyond the screen 32 within the peripheral foam 12 toward the outside edge so far that part of the edge area 24 is embedded in the peripheral foam 12 between the underside of the pane 14 and the fastening element 36.

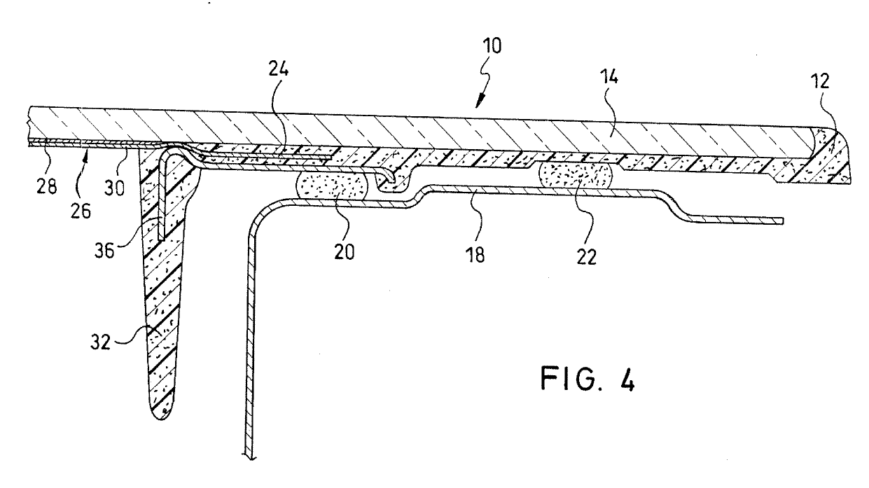

The configuration of the rear area of the pane arrangement 10 from FIG. 3, which is shown in FIG. 4, differs from the front part which is shown in FIG. 3 essentially in that, here, the second cement bond 22 is not located in the part of the peripheral foam 12 which projects beyond the edge of the pane 14, but is offset toward the middle of the pane. The first cement bond 20 is also offset toward the middle of the pane with respect to the arrangement from FIG. 3.

FIG. 5 shows a modification of the embodiment from FIG. 3, here, the connection between the pane arrangement 10 and the retaining element 18 taking place not by means of a cement bond, but by means of a screw connection 40. For this purpose, the fastening element 36, in the area which forms the underside of the peripheral foam 12 (i.e., in the area in which the fastening element 36), is not completely embedded in the peripheral foam 12, but lies exposed at its underside and is provided with a threaded bolt 42 which is, for example, welded onto the sheet metal profile which forms the fastening element 36 or is stamped with it. The threaded bolt 42 extends downward through an opening 14 which is made in the retaining element 18, a nut 46 being screwed onto the bolt 42 from underneath, in order to keep it engaged to the retaining element 46. There are preferably spreaders 48 between the nut 46 and the retaining element 18 and between the fastening element 36 and the retaining element 18. Instead of the second cement bond 22 projecting beyond the edge of the pane on the bottom of the area of the peripheral foam 12, there is a spacer 50 between the peripheral foam 12 and the retaining element 18.

In all embodiments, the edge area 24 of the peripheral foam 26 can be provided with means to achieve better adhesion between the peripheral foam 12 and the cement bond 20 and the edge area 24 of the protective film composite 26; this can be done, for example, by providing holes in the edge area 24 which can be penetrated by the adhesive or the foam mass (as in commonly-owned, co-pending U.S. patent application Ser. No. 10/880,096 which is hereby incorporated by reference) or by special treatment of the /urface of the edge area 24, for example, by mechanical surface roughening or by applying a primer system.

The cement bonds 20, 22 can be produced, for example, by means of a silicone cement or a PU-based cement.

The cement bond between the protective film 30 and the pane 14 can be achieved, instead of with a cement film 28, also by applying the cement to the pane 14 over a large area and then placing and pressing the shatter-proofing film 30 on it.

Furthermore, a function element, such as, for example, a flat solar cell combination, can be enclosed between the protective film composite 28 and the underside of the glass pane 14. Here again, reference is made to the above noted commonly-owned, co-pending U.S. patent application Ser. No. 10/880,096.

In order to achieve an improved visual appearance of the shatter-proofing film 30 from the vehicle interior, the protective film 30 can be provided with a defined, non-flat surface structure, for example, a “grained” structure being produced by means of a die. Alternatively, the protective film foam 30 can be provided with an imprinted regular pattern or can be colored over its entire thickness. The printing can be made such that certain sections of the solar cell combination, for example, the solar cell connectors, are covered. Preferably, both the pane and also the shatter-proofing film are at least partially transparent. However, applications are also possible in which the pane and/or the shatter-proofing film are made opaque. In particular, when there is a solar cell film composite, it can be feasible for the shatter-proofing film to be made at least partially opaque, while the pane is transparent.

The retaining element 18, if the pane arrangement 10 is made as a glass fixing element, can be especially a roof-mounted frame or the bow of such a frame. Instead of a retaining element 18 which is securely joined to the body, analogously, part of the vehicle body can be directly connected to the pane or shatter-proofing element by means of the cement bond or peripheral foam. In this case, the retaining element 18 forms part of the vehicle body, for example, a frame of a roof opening.

When the pane arrangement 10 is made as a movable cover, the retaining element 10 is the inner cover sheet, by means of which the pane arrangement 10 is linked to the positioning mechanism.

Basically, in all embodiments, instead of a shatter-proofing film, the shatter-proofing element can be a shatter-proofing plate, these two versions differing essentially by way of flexural elasticity, and thus, for a given material, by way of the layer thickness of the shatter-proofing element.

Furthermore, although in the illustrated embodiments only a single shatter-proofing element is shown, basically the pane can have several shatter-proofing elements arranged flat next to one another.

Basically, the linking of the shatter-proofing element to the retaining element or the vehicle body can take place by means of cement bonds or screw connections in the edge area of the shatter-proofing element and the pane (this is generally the most advantageous), but alternatively, also farther to the inside in a region of the pane and/or of the shatter-proofing element.

Furthermore, it goes without saying that, in this application, the concept of “peripheral foam” should generally be understood such that a foam mass is applied to the surface, the foam mass not necessarily having to surround the peripheral edge of this surface.

In general, the linking of the shatter-proofing element to the cement bond or peripheral foam can take place either in the entire peripheral edge area of the shatter-proofing element or in segments only in partial regions of the peripheral edge area.

1-29. (canceled)

30. Arrangement for closing an opening of a motor vehicle, comprising:
a pane,
a shatter-proofing element attached to the pane,
a first permanent elastic cement bond connecting the shatter-proofing element to one of a vehicle body and a retaining element which is connected to the vehicle body,
peripheral foam in an edge area of the pane, and
a second permanent elastic cement bond connecting the peripheral foam to said one of the vehicle body and the retaining element.

31. Arrangement as claimed in claim 30, wherein the edge area of the shatter-proofing element is free of the pane and extends into the cement bond.

32. Arrangement as claimed in claim 30, wherein the first cement bond is located in the edge area of the pane and connects the pane to said one of the vehicle body and the retaining element which is connected to the vehicle body.

33. Arrangement as claimed in claim 30, wherein the shatter-proofing element lies between at least a portion of the retaining element and the pane.

34. Arrangement as claimed in claim 30, wherein the second cement bond lies in a region of the peripheral foam which projects beyond the edge of the pane.

35. Arrangement as claimed in claim 30, wherein the shatter-proofing element is attached directly to the pane.

36. Arrangement for closing an opening of a motor vehicle, comprising:
a pane,
a shatter-proofing element attached to the pane,
peripheral foam on an edge area of the pane and the shatter-proofing element,
the peripheral foam being connected to one of a vehicle body and a retaining element which is connected to the vehicle body, and
at least one permanent elastic cement bond connecting the peripheral foam to said one of the vehicle body and the retaining element.

37. Arrangement as claimed in claim 36, wherein said at least one permanent elastic cement bond is an outer second of two permanent elastic cement bonds, a first permanent elastic cement bond being provided between the peripheral foam and the pane.

38. Arrangement as claimed in claim 36, wherein a recess has been mechanically worked into an outer surface of the peripheral foam and wherein a first of said at least one permanent elastic cement bond is attached to the peripheral foam in said recess.

39. Arrangement as claimed in claim 36, wherein the shatter-proofing element is attached directly to the pane.

40. Arrangement as claimed in claim 37, wherein a fastening element which is partially embedded in the peripheral foam is connected to the retaining element by said first permanent elastic cement bond.

41. Arrangement as claimed in claim 40, wherein the fastening element is nearer a middle area of the pane than a region of the second cement bond.

42. Arrangement for closing an opening of a motor vehicle, comprising:
a pane,
a shatter-proofing element attached to the pane,
peripheral foam on an edge area of shatter-proofing element and the pane,
a fastening element partially embedded in said foam,
a permanent elastic cement bond connecting the fastening element to one of a vehicle body and a retaining element which is connected to the vehicle body.

43. Arrangement as claimed in claim 42, wherein the shatter-proofing element is attached directly to the pane.

44. Arrangement as claimed in claim 43, wherein said permanent elastic cement bond is a first permanent elastic cement bond and wherein a second permanent elastic cement bond is provided between the peripheral foam and the pane, offset from the first cement bond.

45. Arrangement as claimed in claim 44, wherein the fastening element is nearer to the middle of the pane than a region of the second permanent elastic cement bond.

46. Arrangement for closing an opening of a motor vehicle, comprising:
a pane,
a shatter-proofing element attached to the pane,
peripheral foam on an edge area of shatter-proofing element and the pane,
a fastening element partially embedded in said foam,
a screw connection connecting the fastening element to one of a vehicle body and a retaining element which is connected to the vehicle body, and
at least one spacer element located between the peripheral foam and said one of the vehicle body and the retaining element.

47. Arrangement as claimed in claim 46, wherein a threaded bolt is connected to and projects downward from the fastening element, the threaded bolt forming part of the screw connection.

48. Arrangement as claimed in claim 46, wherein the fastening element is a sheet metal profile.

49. Arrangement as claimed in claim 40, wherein the fastening element is a sheet metal profile.

50. Arrangement as claimed in claim 44, wherein the second cement bond is located in a region of the peripheral foam which projects beyond the edge of the pane.

51. Arrangement as claimed in claim 36, wherein part of the peripheral foam forms a screen that projects down from the pane and is located inward of the retaining element when viewed from the pane edge and.

52. Arrangement as claimed in claim 51, wherein the shatter-proofing element extends into the screen.

53. Arrangement as claimed in claim 51, wherein the fastening element extends into the screen.

54. Arrangement as claimed in claim 36, wherein the edge area of the shatter-proofing element is free of the pane and extends into the peripheral foam.

55. Arrangement as claimed in claim 30, wherein each cement bond is formed by a cement bead.

56. Arrangement as claimed in claim 30, wherein the arrangement forms a glass cover for a roof opening.

57. Arrangement as claimed in claim 30, wherein the retaining element is one of a reinforcing frame, a bow and an inner cover sheet.
